(19) United States
(12) Patent Application Publication
(10) Pub. No.: US 2018/0003588 A1
(43) Pub. Date: Jan. 4, 2018

(54) MACHINE LEARNING DEVICE WHICH LEARNS ESTIMATED LIFETIME OF BEARING, LIFETIME ESTIMATION DEVICE, AND MACHINE LEARNING METHOD

(71) Applicant: FANUC CORPORATION, Yamanashi (JP)

(72) Inventor: Shunsuke IWANAMI, Yamanashi (JP)

(21) Appl. No.: 15/623,360

(22) Filed: Jun. 14, 2017

(30) Foreign Application Priority Data
Jul. 4, 2016 (JP) 2016-132529

(51) Int. Cl. G01M 13/04; G06N 5/04; G06N 99/00

(52) U.S. Cl. CPC G01M 13/045; G06N 99/005; G01M 13/04; G06N 5/04

(57) ABSTRACT

A machine learning device, which learns an estimated lifetime of a bearing, includes a state observation unit which observes a state variable including at least one of a vibration, a sound, a temperature, and a load of the bearing; and a learning unit which learns the estimated lifetime of the bearing based on an output of the state observation unit.

### BACKGROUND OF THE INVENTION

### 1. Field of the Invention

The present invention relates to a machine learning device which learns an estimated lifetime of a bearing, a lifetime estimation device, and a machine learning method.

### 2. Description of the Related Art

Hitherto, for example, in an industrial machine, such as a machine tool and a robot, a large number of various bearings, have been used for, e.g., a motor. In such bearings, normally, it is configured that an estimated lifetime is set and the bearings and a machine component are replaced on the basis of the estimated lifetime.

In other words, for example, a cause of trouble of a spindle of the machine tool or the motor which drives the spindle is often deterioration and breakage of a bearing of the spindle or the motor. If the machine tool is used while the spindle is completely in trouble, for example, machining precision of a workpiece decreases, which results in a defective product. Further, if recovery of the spindle takes time, a long downtime (stop time) of the machine tool occurs, which consequently leads to a decrease in operating rate of the machine tool.

Then, it has been the practice to estimate a lifetime of a bearing based on an estimated lifetime in which a lifetime of the bearing is estimated and replace the bearing and a machine component prior to a trouble of the bearing. However, the estimated lifetime of the bearing has been created on the basis of, for example, a result of desktop calculation by an engineer, an experiment result, and the like and has not been necessarily considered to reflect an actual use.

Incidentally, hitherto, various propositions have been put forward to more accurately obtain an estimated lifetime of a bearing. For example, Japanese Patent No. 5910124 (Patent Literature 1) discloses a method for estimating a remaining lifetime of a bearing in which the bearing provided into a machine device is nondestructively inspected and the remaining lifetime of the bearing is precisely estimated (an estimated lifetime is determined with precision). In the method for estimating a remaining lifetime of a bearing as disclosed in Patent Literature 1, using an eddy current device which outputs an excitation current of a variable frequency, the frequency of the excitation current applied to a test coil is made to vary in a plural stepwise manner from a high frequency range to a low frequency range, and an output voltage of the test coil before and after the bearing is used is detected for each frequency of the excitation current. Further, a first differential which is a difference of an output voltage for each frequency of the excitation current before and after the bearing is used and a second differential which is a difference between the first differentials between frequencies adjacently set are calculated and, using the second differential based on a degree of a structural variation of the bearing in a depth direction before and after the use, the remaining lifetime of the bearing is estimated.

In addition, for example, Japanese Patent No. 2963146 (Patent Literature 2) discloses a device for predicting a remaining lifetime of a bearing which can predict the remaining lifetime with high precision at a stage at which peeling is extremely minute (initial stage) (determine an estimated lifetime with high precision), and has excellent versatility. The device for predicting a remaining lifetime of a bearing as disclosed in Patent Literature 2 detects acoustic emission (AE) from the bearing by an AE sensor, compares an AE signal from the AE sensor with a threshold value, and calculates a generation cycle of the AE signal in which the AE signal exceeds the threshold value. Further, a number of generations in each generation cycle as calculated is counted to be divided by a theoretical number of generations of each of parts corresponding to each generation cycle, an AE generation probability of each of the parts is calculated, and a gradient of the AE generation probability as calculated relative to a time is calculated. Then, on the basis of the gradient as calculated and the AE generation probability at a time at which the gradient is determined, the remaining lifetime is calculated.

Further, for example, Japanese Patent No. 3891049 (Patent Literature 3) discloses a method for estimating a remaining lifetime of a bearing and a device for estimating a remaining lifetime of a bearing which can estimate the remaining lifetime of the bearing without disassembling a unit of the bearing and accurately perform such estimation (can accurately determine an estimated lifetime). In a technique of estimating a lifetime of a bearing as disclosed in Patent Literature 3, for example, after the start of use, a property of a lubricant is measured, a degree of an influence on a lifetime of the bearing is converted from information on the property of the lubricant as measured, and the lifetime of the bearing is calculated.

As described above, hitherto, an estimated lifetime of a bearing is to be created based on, for example, a result of desktop calculation by an engineer, an experiment result, and the like and does not reflect an actual use.

Further, as a configuration to more accurately obtain an estimated lifetime of a bearing, for example, such propositions as Prior Art Literatures 1-3 have been made, each of which is, however, to obtain an estimated lifetime of a bearing based on a predetermined algorithm. However, because the estimated lifetime of the bearing varies due to a usage condition of the bearing, an environment, and the like, and further, there are various modes of breakage of the bearing, in each of Prior Art Literatures 1-3, the estimated lifetime of the bearing as obtained has not been necessarily considered to be satisfactory.

In view of the problem of the prior art as described above, it is an object of the present invention to provide a machine learning device which can obtain an estimated lifetime of a bearing based on an actual environment in which the bearing is actually used, a lifetime estimation device, and a machine learning method.

### SUMMARY OF INVENTION

According to a first aspect of the present invention, there is provided a machine learning device which learns an estimated lifetime of a bearing, including a state observation unit which observes a state variable including at least one of a vibration, a sound, a temperature, and a load of the bearing; and a learning unit which learns the estimated lifetime of the bearing based on an output of the state observation unit.

The machine learning device may further include a decision unit which determines an estimated life variation curve in which a lifetime of the bearing is estimated by referring to the estimated lifetime as learned by the learning unit. The learning unit may include a reward calculation unit which calculates a reward based on the output of the state observation unit; and a value function update unit which updates a value function relating to the estimated lifetime of the bearing based on the output of the state observation unit and an output of the reward calculation unit in accordance with the reward. The reward calculation unit may provide a negative reward when an amount of difference between a transition of a state variation of the bearing based on the state variable and a state variation as estimated is greater than or equal to a predetermined value, and may provide a positive reward when the amount of difference between the transition of the state variation of the bearing based on the state variable and the state variation as estimated is less than the predetermined value.

The machine learning device may further include a data obtaining unit which obtains data including at least one of a type, a size, an environmental condition, a usage condition, and an operation time of the bearing, wherein the learning unit may learn the estimated lifetime of the bearing based on the output of the state observation unit and an output of the data obtaining unit. In the estimated lifetime of the plurality of bearings, the learning unit may learn the estimated lifetime of the bearing as determined based on the output of the data obtaining unit. The learning unit may include a neural network. The machine learning device may be configured to share or exchange data with another machine learning device via a network. The learning unit may update an action value table of its own using another action value table updated by the learning unit of another machine learning device. The machine learning device may be located on a cloud server.

According to a second aspect of the present invention, there is provided a lifetime estimation device including the machine learning device according to the above first aspect, and a bearing lifetime display device which displays the estimated lifetime of the bearing as learned.

According to a third aspect of the present invention, there is provided a machine learning method which learns an estimated lifetime of a bearing, including observing a state variable including at least one of a vibration, a sound, a temperature, and a load of the bearing; and learning the estimated lifetime of the bearing based on the variable as observed.

The machine learning method may further include determining an estimated life variation curve in which a lifetime of the bearing is estimated by referring to the estimated lifetime as learned. Learning of the estimated lifetime may include calculating a reward based on the state variable as observed; and updating a value function relating to the estimated lifetime of the bearing based on the state variable as observed and the reward as calculated in accordance with the reward. In calculating the reward, a negative reward may be provided when an amount of difference between a transition of a state variation of the bearing based on the state variable and a state variation as estimated is greater than or equal to a predetermined value, and a positive reward may be provided when the amount of difference between the transition of the state variation of the bearing based on the state variable and the state variation as estimated is less than the predetermined value.

### BRIEF DESCRIPTION OF THE DRAWINGS

The present invention will be understood more clearly by referring to the following accompanying drawings.

FIG. 1 is a block diagram illustrating an embodiment of a machine learning device of the present invention;

FIG. 2 is a block diagram illustrating a part of an industrial machine to which the machine learning device as illustrated in FIG. 1 is applied;

FIG. 3 is a diagram schematically illustrating a model of a neuron;

FIG. 4 is a diagram schematically illustrating a three-layer neural network configured by combining the neurons as illustrated in FIG. 3;

FIG. 5 is a flowchart for illustrating an example of an operation of the machine learning device as illustrated in FIG. 1;

FIG. 6A, FIG. 6B, and FIG. 6C are diagrams for illustrating an example of processing of an estimated lifetime of a bearing by the machine learning device as illustrated in FIG. 1;

FIG. 7 is a flowchart for illustrating another example of the operation of the machine learning device as illustrated in FIG. 1; and

FIG. 8 is a diagram for illustrating an example of processing of the estimated lifetime of the bearing.

### DETAILED DESCRIPTION

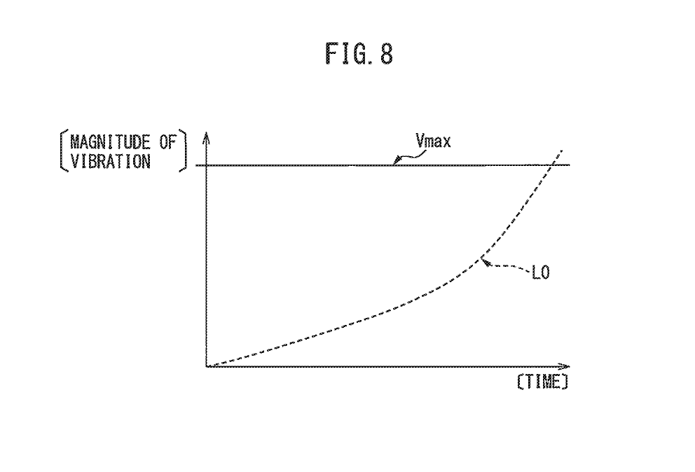

First, an example of processing of an estimated lifetime of a bearing will be described with reference to FIG. 8 before embodiments of a machine learning device, a lifetime estimation device, and a machine learning method of the present invention are described in detail. FIG. 8 is a diagram for illustrating an example of processing of an estimated lifetime of a bearing and illustrates a variation of a magnitude of vibration relative to an operation time (elapsed time) of the bearing. Note that in FIG. 8, a reference sign Vmax denotes a magnitude of vibration when a lifetime of the bearing comes to an end (lifetime vibration), and a reference sign L0 denotes a mode of a variation of the estimated lifetime of the bearing relative to the elapsed time (estimated lifetime variation curve).

As illustrated in FIG. 8, the estimated lifetime variation curve L0 is indicated as a variation of a magnitude of vibration relative to an elapsed time from an initial state at which an use of the bearing is started until the magnitude of vibration exceeds the lifetime vibration Vmax, for example, on the basis of a result of desktop calculation by an engineer, an experiment result. Then, for example, when the estimated lifetime variation curve L0 of a certain bearing exceeds the lifetime vibration Vmax, the bearing is replaced and the like, assuming that the lifetime comes to an end.

Thus, the estimated lifetime variation curve L0 as illustrated in FIG. 8 is created, for example, on the basis of a result of desktop calculation by an engineer, an experiment result, and the like and is not necessarily considered to reflect an actual use of the bearing. In other words, the lifetime of the bearing is considered to vary due to a usage condition of the bearing, an environment, and the like. Thus, for example, if the estimated lifetime variation curve L0 is set while a margin is generously estimated, even when a further longer use is actually possible, it is determined beforehand that the lifetime of the bearing comes to an end, and replacement and the like are performed. On the contrary, if the estimated lifetime variation curve L0 is set while a margin is ungenerously estimated, although it is determined that the lifetime of the bearing does not come to an end, a trouble of the bearing occurs, which causes a decrease of machining precision of a workpiece and an occurrence of a long downtime of the machine tool.

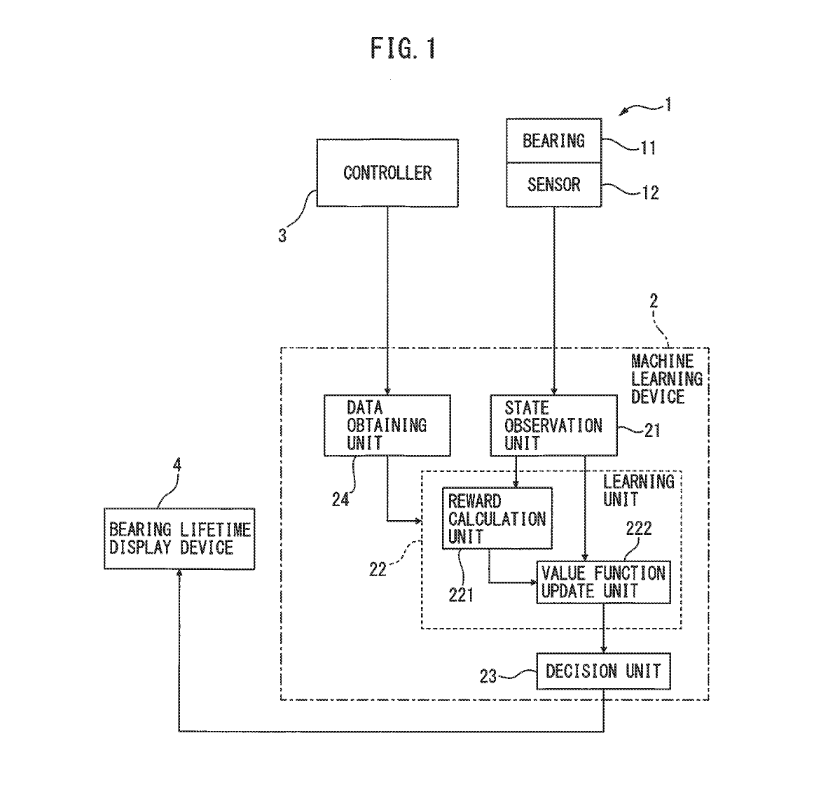

Hereinafter, embodiments of the machine learning device, the lifetime estimation device, and the machine learning method of the present invention will be described in detail with reference to the accompanying drawings. FIG. 1 is a block diagram illustrating an embodiment of the machine learning device of the present invention and illustrates an example of the machine learning device to which “reinforcement learning (Q-learning)” is applied.

As illustrated in FIG. 1, a machine learning device 2 is to learn an estimated lifetime of a bearing 11, and includes a state observation unit 21, a learning unit 22, a decision unit 23, and a data obtaining unit 24. To the state observation unit 21, a state quantity (state variable), such as a vibration, a sound, a temperature, and a load of the bearing 11, obtained, for example, by each type of sensor 12 provided directly to the bearing 11 or mounted in the vicinity of the bearing 11 is inputted. Note that the state observation unit 21 does not need to receive all of the vibration, the sound, the temperature, and the load of the bearing 11, but receives at least one of the same as the state variable. Further, the state variable received by the state observation unit 21 is not limited to the vibration, the sound, the temperature, and the load of the bearing 11, and another information relating to the bearing 11 may be received as the state variable. In addition, in FIG. 1, the bearing 11 and the sensor 12 are combined, which is denoted by a reference sign 1.

The data obtaining unit 24 obtains data of a type, a size, an environmental condition, a usage condition, and an operation time of the bearing 11 from a controller 3 and provides an output based on the data as obtained to the learning unit 22. The data obtaining unit 24 does not need to receive all the data of the type, the size, the environmental condition, the usage condition, and the operation time of the bearing 11, but may receive at least one of the same or further receive another data. Further, the environmental condition and the usage condition include, for example, a temperature and a humidity of the surrounding at which the bearing is used, a load which is set, and the like.

The learning unit 22 recognizes and learns, for example, the type and the size of the bearing 11 and the like which are a target, on the basis of the output of the data obtaining unit 24. Note that, for example, when the bearing 11 which is a target of the machine learning device 2 is determined to be of one type and a surrounding environment is stable, and the like, the data obtaining unit 24 may be not necessarily provided. Alternatively, it is needless to say that the data, such as the type, the size, the environmental condition, the usage condition, and the operation time of the bearing 11, can be inputted to the state observation unit 21 as well. Further, the controller 3 is supposed to be, such as a computerized numerical control (CNC) device and a robot controller, which grasps information, such as the type, the size, the environmental condition, the usage condition, and the operation time of the bearing 11, but the data inputted to the data obtaining unit 24 is not limited to that from the controller 3, and may be various, for example, including that inputted by an operator.

The learning unit 22 is to learn the estimated lifetime of the bearing 11 based on an output of the state observation unit 21 and the output of the data obtaining unit 24, and includes a reward calculation unit 221 and a value function update unit 222. The reward calculation unit 221 calculates a reward based on the output of the state observation unit 21, and the value function update unit 222 updates a value function relating to the estimated lifetime of the bearing 11 on the basis of the output of the state observation unit 21 and an output of the reward calculation unit 221 in accordance with the reward. The decision unit 23 determines an estimated lifetime variation curve in which a lifetime of the bearing 11 is estimated by referring to the estimated lifetime as learned by the learning unit 22. Note that a bearing lifetime display device 4 displays the estimated lifetime of the bearing 11, for example, on the basis of an output of the decision unit 23. The bearing lifetime display device 4 can be provided, for example, as a display unit of the lifetime estimation device to which the machine learning device 2 is provided, and can display, for example, a remaining lifetime of the bearing 11 based on the output of the decision unit 23 or display a period until the bearing 11 is to be replaced. Further, it may be configured that an alarm indicating a replacement time of the bearing 11, and the like is sounded when the lifetime of the bearing 11 is about to come to an end.

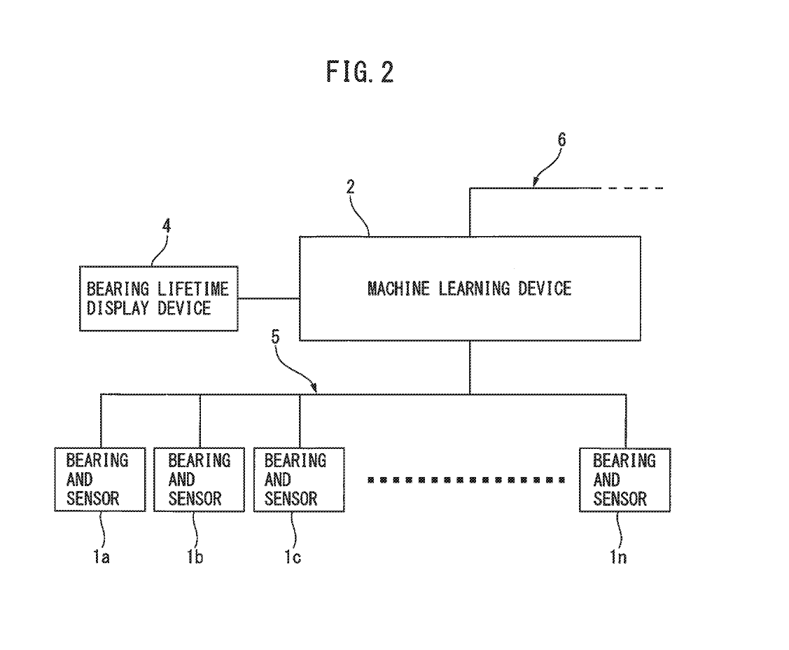

FIG. 2 is a block diagram illustrating a part of an industrial machine to which the machine learning device as illustrated in FIG. 1 is applied, and illustrates a case in which the machine learning device 2 is provide with respect to n pieces of bearings and sensors 1a-1n. Each of the bearings and sensors 1a-1n corresponds to the bearing 11 and the sensor 12 denoted by the reference sign 1 in FIG. 1 and is connected through a signal line 5 to the machine learning device 2. Note that the bearings and sensors 1a-1n are each configured to be the bearing 11 and the sensor 12 of the same specification.

To each bearing (11) in the bearings and sensors 1a-1n, each type of sensor (12) is mounted directly or in the vicinity thereof, and a signal from each type of sensor is inputted through the signal line 5 to the machine learning device 2. In other words, to the machine learning device 2 (state observation unit 21), for example, the state variable, such as the vibration, the sound, the temperature, or the load from each of the bearings 11 and sensors 1a-1n, is inputted. Further, to the data obtaining unit 24, although omitted in FIG. 2, data, such as the type, the size, the environmental condition, the usage condition, and the operation time of each bearing (11) in the bearings and sensors 1a-1n, is inputted.

A case in which in the bearing and sensor 1a, for example, the lifetime comes to an end when a magnitude of vibration (vibration acceleration) of the bearing (11) reaches fa [m/s²] is examined. Note that the vibration acceleration (state variable) at each elapsed time (time) is inputted through the signal line 5 to the state observation unit 21 of the machine learning device 2 including the learning unit 22 to be recorded (stored). The learning unit 22 estimates the lifetime of each bearing (11) based on information accumulated in the machine learning device 2. For example, a situation of the bearing 11 at an initial stage after operation start (initial state) and a situation of the bearing 11 when a certain time elapses from an operation start are compared with each other, and supposing f(t)=fa in terms of time function, a lifetime t is estimated. Further, the function f(t) of a situation of the bearing 11 which is estimated by the learning unit 22 at certain intervals and a variation f(tr) of an actual situation of the bearing 11 are compared with each other.

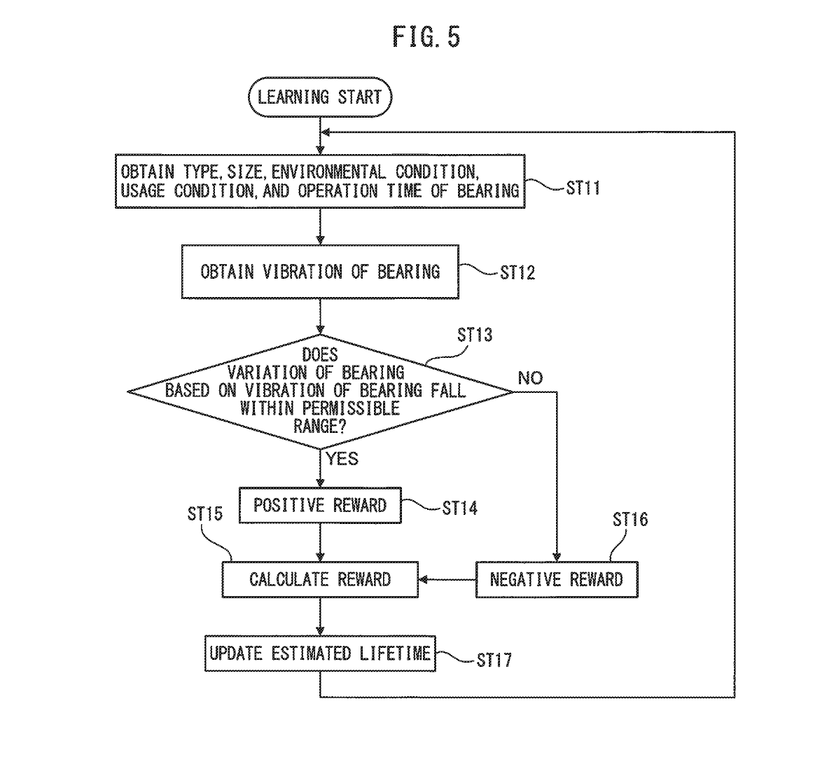

For example, when a permissible range of the estimated lifetime is PR, in the reward calculation unit 221, if |f(t)−f(tr)|<PR holds true, a positive reward is set, whereas, if |f(t)−f(tr)|≧PR holds true, a negative reward is set. Then, the value function update unit 222 updates the value function which determines the estimated lifetime on the basis of the output of the state observation unit 21 and the reward calculated by the reward calculation unit 221. Thereby, for example, without depending on a specification and an environment of the bearing 11, accurately estimating the lifetime of the bearing 1 is enabled. Note that such processing will be later described with reference to FIG. 5 to FIG. 7.

Incidentally, as illustrated in FIG. 2, the machine learning device 2 can be connected via a network 6, such as Ethernet (registered trademark) and the Internet, to another machine learning device (2), and can mutually share and exchange data with another machine learning device. In addition, the machine learning device 2 can be provided, for example, to an industrial machine in which the bearing 11 is used or in the vicinity thereof, or in a factory having such an industrial machine, and the like, which is, however, not limitative, and, for example, can be also provided on a cloud server via the network 6. Further, the machine learning device 2 and the bearing lifetime display device 4 can be also housed in the controller 3, and the controller 3 can have a function as a lifetime estimation device.

The machine learning device 2 according to the present embodiment as described above can be widely applied to various machined in which the bearing 11 is employed, particularly, replacement of the bearing 11 (replacement of a component including the bearing 11) is possible, and further, great effects can be expected when the machine learning device 2 is applied to such an industrial machine that when a trouble due to deterioration and breakage of the bearing 11 occurs, machining precision of a workpiece decreases and a downtime occurs. As such an industrial machine, various industrial robots and machine tools can be employed. Further, the machine learning device is not limited to the machine learning device 2 to which “reinforcement learning (Q-learning)” is applied as illustrated by referring to FIG. 1.

Incidentally, the machine learning device has functions of analytically extracting, from a set of data as inputted into the device, a useful rule, a knowledge representation, a criterion for judgment or the like contained therein, outputting a result of the judgment, and performing knowledge learning (machine learning). The technique of the machine learning is various, and is broadly classified as, for example, “supervised learning”, “unsupervised learning”, and “reinforcement learning”. Further, there is a technique referred to as “deep learning” that learns extraction of a feature value per se in order to implement these techniques.

As described above, the machine learning device 2 as illustrated in FIG. 1 illustrates an example in which “reinforcement learning (Q-learning)” is applied, and the machine learning device 2 can use a general-purpose computer or a processor as well, but if, for example, general-purpose computing on graphics processing units (GPGPU), large-scale PC clusters or the like is applied, higher processing is possible.

Note that in supervised learning, supervised data, i.e., a large quantity of data sets of some input and results (labels) are provided to the machine learning device to learn features in the data sets and inductively obtain a model (error model) for estimating the result from the input, i.e., a relationship thereof. For example, it can be implemented using an algorithm, such as a neural network as described below.

Unsupervised learning is a technique in which a large quantity of input data alone are provided to the learning device to learn how the input data is distributed and the device that performs compression, sorting, shaping or the like with respect to the input data performs learning without being provided with corresponding teacher output data. For example, similar features in the data sets can be clustered, and the like. Using this result, it is possible to achieve prediction of output by allocating outputs such that some criteria is defined to optimize the result.

Further, as intermediate problem setting between unsupervised learning and supervised learning, there is one referred to as semi-supervised learning. This corresponds to a case, for example, in which there are only some data sets of inputs and outputs and in the remaining data are only inputs. In the present embodiment, it is possible to perform learning efficiently, in unsupervised learning, by using data (image data, simulation data, and the like) that can be obtained without actually operating an industrial machine cell (plurality of industrial machines).

Next, reinforcement learning will be described further in detail. First, a problem of reinforcement learning is set as follows.
For example, a device for estimating a lifetime of a bearing (machine learning device) observes a state of environment and determines an action.
Environment changes in accordance with some rule, and further, one's own action may change the environment.
A reward signal returns each time the action is performed.
It is the sum of (discounted) reward over the future, which is desired to be maximized.
Learning starts from a state in which the result caused by the action is not known or only incompletely known. In other words, a numerical control device can obtain the result as data only after it actually operates. In short, it is preferable to explore the optimum action by trial and error.
By setting a state in which prior learning (a technique, such as supervised learning as described above or inverse reinforcement learning) is performed to mimic a human movement as the initial state, learning may be started from a good starting point.

Herein, reinforcement learning is a technique, not only by determination or sorting but also by learning actions, for learning an appropriate action based on the interaction provided by an action to environment, i.e., for learning how to maximize the reward obtained in the future. Hereinafter, for example, description is continued with respect to the case of Q-learning, but the machine learning method is not limited to Q-learning.

Q-learning is a method for learning a value Q(s, a) for selecting an action a in a certain environmental state s. In other words, in a certain state s, an action a with the highest value Q(s, a) may be selected as the optimum action. However, first, the correct value for the value Q(s, a) is completely not known for a pair of the state s and the action a. Accordingly, an agent (action subject) selects various actions a under a certain state s and is given a reward for the action a at that time. Consequently, the agent learns to select a better action, i.e., learn the correction value Q(s, a).

Further, as a result of action, it is desired to maximize the sum of the rewards obtained in the future, and finally, it is aimed to satisfy Q(s, a)=E[Σγ^{t}rₜ]. Herein, the expected value is taken for the case when the state varies in accordance with the optimum action, and since it is not known, it is learned while making exploration). An update formula for such value Q(s, a) may be represented, for example, by equation (1) as follows:

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( 1 )$$

In the above equation (1), sₜ represents a state of the environment at a time t, and aₜ represents an action at the time t. The action aₜ changes the state to sₜ₊₁. rₜ₊₁ represents a reward that can be gained with the change of the state. Further, the term attached with max is the Q-value multiplied by γ for the case where the action a with the highest Q-value known at that time is selected under the state sₜ₊₁. Herein, γ is a parameter satisfying 0<γ≦1, and referred to as a discount rate. Further, α is a learning factor, which is in the range of 0<α≦1.

The above equation (1) represents a method for updating the evaluation value Q(sₜ, aₜ) of the action at in the state sₜ on the basis of the reward rₜ₊₁ has returned as a result of the action aₜ. In other words, it is indicated that when the evaluation value Q(sₜ₊₁, max aₜ₊₁) of the best action max a in the next state based on reward rₜ₊₁+action a is larger than the evaluation value Q(sₜ, aₜ) of the action a in the state s, Q(sₜ, aₜ) is increased; on the contrary, when Q(ₛₜ₊₁, max ₐₜ₊₁) is smaller, Q(sₜ, aₜ) is decreased. In other words, it is configured such that a value for a certain action in a certain state is made to be closer to the reward that is instantly returned as a result and the value for the best action in the next state based upon that action.

Herein, methods of representing Q(s, a) on a computer include a method in which values for all state-action pairs (s, a) are held as a table (action value table) and a method in which a function approximate to Q(s, a) is prepared. In the latter method, the above equation (1) can be implemented by adjusting parameters of the approximation function using a technique, such as a stochastic gradient descent method. Note that, as the approximation function, a neural network described hereinafter may be used.

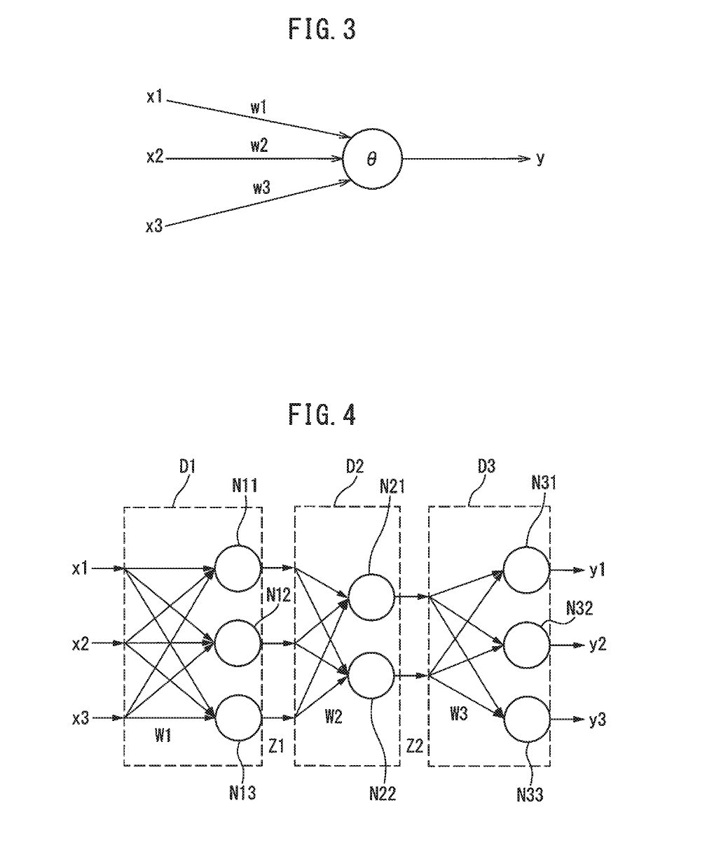

Herein, as an approximation algorithm for a value function in reinforcement learning, a neural network may be used. FIG. 3 is a diagram schematically illustrating a model of a neuron, and FIG. 4 is a diagram schematically illustrating a three-layer neural network configured by combining neurons illustrated in FIG. 3. In other words, the neural network is configured, for example, of an arithmetic device simulating a model of a neuron as illustrated in FIG. 3, a memory, and the like.

As illustrated in FIG. 3, the neuron outputs an output (result) y for a plurality of inputs x (in FIG. 3, by way of example, input x1 to x3). Each of the inputs x (x1, x2, x3) is multiplied by a weight W (W1, W2, W3) corresponding to the input x. Thereby, the neuron outputs the result y represented by the following equation [6]. Note that all of the input x, the result y, and the weight w all are vectors. Further, in the equation (2) below, θ is a bias, and fₖ is an activation function.

y=fₖ(Σ_{f=1}ⁿx₁w₁−θ (2)

Referring to FIG. 4, a description will be given of a neural network having three-layers, which is made up of a combination of neurons as illustrated in FIG. 3. As illustrated in FIG. 4, a plurality of inputs x (by way of example herein, input x1 to input x3) are inputted from the left hand side of the neural network, and a result y (by way of example herein, result y1 to input y3) is outputted from the right hand side. Specifically, the inputs x1, x2, and x3 are multiplied by a weight corresponding to each of three neurons N11 to N13 and inputted. The weights used to multiply these inputs are collectively represented by W1.

The neurons N11 to N13 output z11 to z13, respectively. In FIG. 4, such z11 to z13 are collectively referred to as a feature vector Z1, which may be regarded as a vector which is obtained by extracting feature values of the input vector. The feature vector Z1 is a feature vector defined between the weight W1 and the weight W2. z11 to z13 are multiplied by a weight corresponding to each of the two neurons N21 and N22 and inputted. The weights used to multiply these feature vectors are collectively represented by W2.

The neurons N21 and N22 output z21 and z22, respectively. In FIG. 4, such z21, z22 are collectively represented by a feature vector Z2. The feature vector Z2 is a feature vector defined between the weight W2 and the weight W3. z21 and z22 are multiplied by a weight corresponding to each of the three neurons N31 to N33 and inputted. The weights used to multiply these feature vectors are collectively represented by W3.

Finally, the neurons N31 to N33 output result y1 to result y3, respectively. The operation of the neural network includes a learning mode and a value prediction mode. For example, in the learning mode, the weight W is learned using a learning data set, and in the prediction mode, the action of the numerical control device is determined using the parameters. Note that reference is made to prediction for convenience, but it is needless to say that various tasks, such as detection, classification, inference, and the like, are possible.

Herein, it is possible that the numerical control device can be actually operated in the prediction mode and instantly learn the obtained data to be reflected in the subsequent action (on-line learning) and also that a group of pre-collected data can used to perform collective learning and execute a detection mode with the parameter since then (batch learning). An intermediate case is also possible, where a learning mode is interposed each time data is accumulated to a certain degree.

The weights W1 to W3 can be learned by an error back propagation method. Note that the error information enters from the right hand side and flows to the left hand side. The error back propagation method is a technique for adjusting (leaning) each weight so as to reduce the difference between an output y when an input x is inputted and a true output y (teacher) for each neuron. Such a neural network can have three or more layers (referred to as deep learning). Further, it is possible to extract features of the input step by step and automatically obtain an arithmetic device, which feeds back the results, from the teacher data alone.

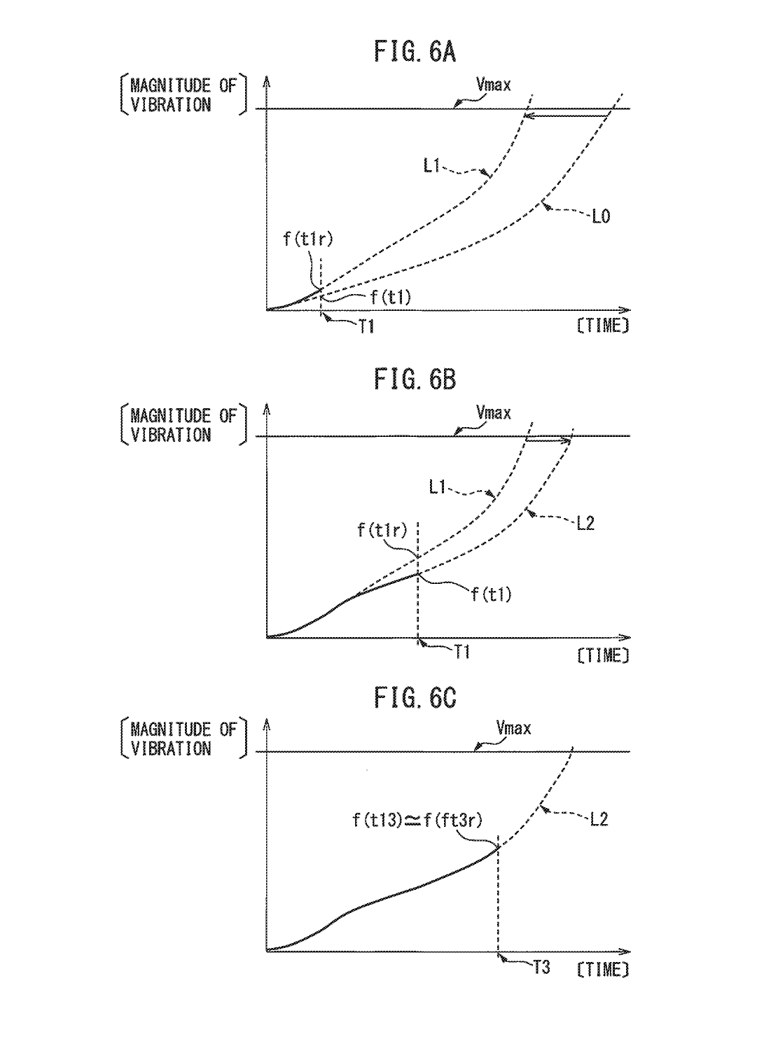

FIG. 5 is a flowchart for illustrating an example of an operation of the machine learning device as illustrated in FIG. 1, and FIG. 6A, FIG. 6B, and FIG. 6C are diagrams for illustrating an example of processing of the estimated lifetime of the bearing by the machine learning device as illustrated in FIG. 1.

First, as illustrated in FIG. 5, when machine learning starts (learning start), at step ST11, the data obtaining unit 24 obtains data, such as a type, a size, an environmental condition, a usage condition, and an operation time of the bearing 11, and the process advances to step ST12. Note that at step ST11, the data obtained by the data obtaining unit 24 may not be all but a part of the type, the size, the environmental condition, the usage condition, and the operation time of the bearing 11, and further, more data may be obtained.

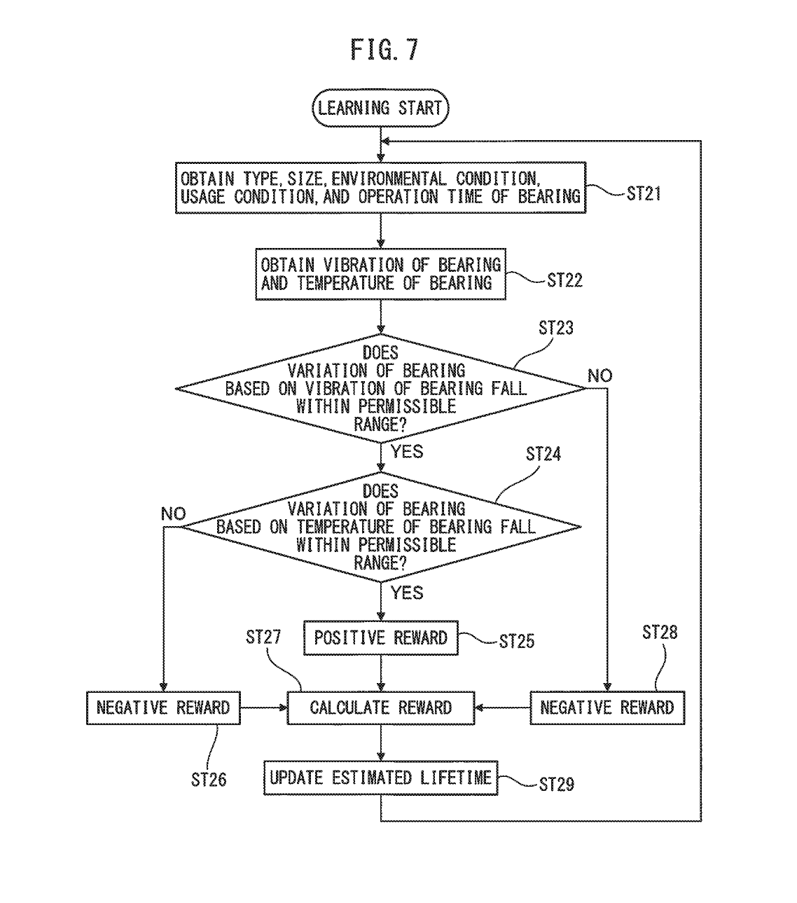

At step ST12, the state observation unit 21 obtains information relating to a vibration of the bearing 11 through the sensor (vibration sensor) 12 provided to the bearing 11. The state observation unit 21 may observe a state variable, for example, including at least one of a vibration, a sound, a temperature, and a load of the bearing 11, which is observed through the each type of sensor 12 provided directly to the bearing 11 or mounted in the vicinity of the bearing 11. Further, the state variable (state quantity) of the bearing 11 observed by the state observation unit 21 may include at least one of the vibration, the sound, the temperature, and the load, but include a plurality thereof or further another state variable. Note that in FIG. 7 as described later, processing based on two state variables (vibration and temperature) of the bearing 11 will be described.

Next, the process advances to step ST13, and it is determined whether a variation of the bearing 11 based on the vibration of the bearing 11 falls within a permissible range of an estimated lifetime. For example, as illustrated in FIG. 6A, at an elapsed time (operation time) T1, supposing that the variation of the bearing 11 based on the vibration of the bearing 11 (vibration actually observed) is f(t1r) and an estimated lifetime variation curve (as initially set, for example) is L0 before the time T1, it is determined whether or not a difference between f(t1r) and a variation f(t1) at the time T1 based on the estimated lifetime variation curve L0 before the time T1 is less than the permissible range PR (|f(t1)−f(t1r)|<PR).

At step ST13, when it is determined that the variation of the bearing 11 based on the vibration of the bearing 11 falls within the permissible range of the estimated lifetime (ST13: YES), i.e., |f(t1)−f(t1r)|<PR holds true, the process advances to step ST14 and a positive reward is set, and the process advances to step ST15. On the other hand, at step ST13, when it is determined that the variation of the bearing 11 based on the vibration of the bearing 11 does not fall within the permissible range of the estimated lifetime (ST13: NO), i.e., |f(t1)−f(t1r)|≧PR holds true, the process advances to step ST16 and a negative reward is set, and the process advances to step ST15.

At step ST15, reward calculation of “the positive reward” at step ST14 and “the negative reward” at step ST16 is performed; the process advances to step ST17, and the estimated lifetime is updated (update of a value function by the value function update unit 222); the process then returns to step ST11, and similar processing is repeated.

FIG. 6A and FIG. 6B are cases in which it is determined at step ST13 that the variation of the bearing 11 based on the vibration of the bearing 11 does not fall within the permissible range of the estimated lifetime (ST13: NO), in other words, it is determined that |f(t1)−f(t1r)|≧PR holds true in FIG. 6A and |f(t2)−f(t2r)|≧PR holds true in FIG. 6B. Thereby, in FIG. 6A, the estimated lifetime variation curve L0 before the time T1 is changed, after the time T1, to a new estimated lifetime variation curve L1 based on the updated value function, and in FIG. 6B, the estimated lifetime variation curve L1 before the time T1 is changed to, after a time T2, a new estimated lifetime variation curve L2 based on the updated value function.

On the other hand, FIG. 6C is a case in which it is determined at step ST13 that the variation of the bearing 11 based on the vibration of the bearing 11 falls within the permissible range of the estimated lifetime (ST13: YES), in other words, it is determined that |f(t1)−f(t1r)|<PR holds true. In this case, a positive reward is set; as a result, the estimated lifetime variation curve L2 before a time T3 remains to be the estimated lifetime variation curve L2 as it is after the time T3. Time intervals at which processing as illustrated in FIG. 5 is performed can be variously set according to the bearing 11 which is a target: for example, the processing may be executed once in one to several hours; or the processing may be executed when a machine tool in which the bearing 11 is employed is started, and the like.

FIG. 7 is a flowchart for illustrating another example of the operation of the machine learning device as illustrated in FIG. 1. Another example of the operation of the machine learning device as illustrated in FIG. 7 corresponds to a case in which in addition to processing based on the vibration of the bearing 11 as illustrated with reference to FIG. 5, processing based on a temperature of the bearing 11 is added.

As illustrated in FIG. 7, when machine learning starts (learning start), at step ST21, the data obtaining unit 24 obtains data, such as a type, a size, an environmental condition, a usage condition, and an operation time of the bearing 11, and the process advances to step ST22. At step ST22, the state observation unit 21 obtains information relating to a vibration and a temperature of the bearing 11 through the sensors (vibration sensor and temperature sensor) 12 provided to the bearing 11.

Next, the process advances to step ST23, and it is determined whether a variation of the bearing 11 based on the vibration of the bearing 11 falls within a permissible range of an estimated lifetime. This is similar to that described with reference to FIG. 5 to FIG. 6C, and description thereof is omitted. Step ST23 and step ST28 in FIG. 7 respectively correspond to step ST13 and ST16 in FIG. 5. Further, the process advances to step ST24, and it is determined whether a variation of the bearing 11 based on the temperature of the bearing 11 falls within the permissible range of the estimated lifetime. Such processing at step ST24 is also similar to the processing at step ST13 in FIG. 5 as described above, and for example, as illustrated in FIG. 6A, at the elapsed time (operation time) T1, supposing that the variation of the bearing 11 based on the vibration of the bearing 11 (temperature actually observed) is f(t1r) and an estimated lifetime variation curve (as initially set, for example) is L0 before the time T1, it is determined whether or not a difference between f(t1r) and a variation f(t1) at the time T1 based on the estimated lifetime variation curve L0 before the time T1 is less than the permissible range PR (|f(t1)−f(t1r)|<PR).

At step ST24, when it is determined that the variation of the bearing 11 based on the temperature of the bearing 11 falls within the permissible range of the estimated lifetime (ST24: YES), i.e., |f(t1)−f(t1r)|<PR holds true, the process advances to step ST25 and a positive reward is set; the process then advances to step ST27. On the other hand, at step ST24, when it is determined that the variation of the bearing 11 based on the temperature of the bearing 11 does not fall within the permissible range of the estimated lifetime (ST24: NO), i.e., |f(t1)−f(t1r)|≧PR holds true, the process advances to step ST26 and a negative reward is set; and the process advances to step ST27.

At step ST27, reward calculation of “the positive reward” at step ST25 and “the negative reward” at step ST26 and step ST28 is performed; the process advances to step ST29, and the estimated lifetime is updated (update of a value function by the value function update unit 222); the process then returns to step ST21, and similar processing is repeated. Note that in FIG. 7, a case in which learning processing is performed on the basis of the vibration and the temperature of the bearing 11 is described, but further, another state variable can be used as well as described above.

The machine learning device, the lifetime estimation device, and the machine learning method of the present invention produce effects in which an estimated lifetime of a bearing based on an actual environment in which the bearing is actually used can be obtained.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A machine learning device which learns an estimated lifetime of a bearing, comprising:
a state observation unit which observes a state variable including at least one of a vibration, a sound, a temperature, and a load of the bearing; and
a learning unit which learns the estimated lifetime of the bearing based on an output of the state observation unit.

2. The machine learning device according to claim 1, further comprising:
a decision unit which determines an estimated life variation curve in which a lifetime of the bearing is estimated by referring to the estimated lifetime as learned by the learning unit.

3. The machine learning device according to claim 1, wherein the learning unit includes:
a reward calculation unit which calculates a reward based on the output of the state observation unit; and
a value function update unit which updates a value function relating to the estimated lifetime of the bearing based on the output of the state observation unit and an output of the reward calculation unit in accordance with the reward.

4. The machine learning device according to claim 3, wherein the reward calculation unit
provides a negative reward when an amount of difference between a transition of a state variation of the bearing based on the state variable and a state variation as estimated is greater than or equal to a predetermined value, and
provides a positive reward when the amount of difference between the transition of the state variation of the bearing based on the state variable and the state variation as estimated is less than the predetermined value.

5. The machine learning device according to claim 1, further comprising:
a data obtaining unit which obtains data including at least one of a type, a size, an environmental condition, a usage condition, and an operation time of the bearing, wherein
the learning unit learns the estimated lifetime of the bearing based on the output of the state observation unit and an output of the data obtaining unit.

6. The machine learning device according to claim 5, wherein, in the estimated lifetime of the plurality of bearings, the learning unit learns the estimated lifetime of the bearing as determined based on the output of the data obtaining unit.

7. The machine learning device according to claim 1, wherein the learning unit includes a neural network.

8. The machine learning device according to claim 1, wherein the machine learning device is configured to share or exchange data with another machine learning device via a network.

9. The machine learning device according to claim 8, wherein the learning unit updates an action value table of its own using another action value table updated by the learning unit of another machine learning device.

10. The machine learning device according to claim 1, wherein the machine learning device is located on a cloud server.

11. A lifetime estimation device comprising:
the machine learning device according to claim 1; and
a bearing lifetime display device which displays the estimated lifetime of the bearing as learned.

12. A machine learning method which learns an estimated lifetime of a bearing, comprising:
observing a state variable including at least one of a vibration, a sound, a temperature, and a load of the bearing; and
learning the estimated lifetime of the bearing based on the variable as observed.

13. The machine learning method according to claim 12, further comprising:
determining an estimated life variation curve in which a lifetime of the bearing is estimated by referring to the estimated lifetime as learned.

14. The machine learning method according to claim 12, wherein learning of the estimated lifetime includes:
calculating a reward based on the state variable as observed; and
updating a value function relating to the estimated lifetime of the bearing based on the state variable as observed and the reward as calculated in accordance with the reward.

15. The machine learning method according to claim 14, wherein, in calculating the reward,
a negative reward is provided when an amount of difference between a transition of a state variation of the bearing based on the state variable and a state variation as estimated is greater than or equal to a predetermined value, and
a positive reward is provided when the amount of difference between the transition of the state variation of the bearing based on the state variable and the state variation as estimated is less than the predetermined value.
